(19) United States
(12) Patent Application Publication
(10) Pub. No.: US 2004/0220006 A1
(43) Pub. Date: Nov. 4, 2004

(54) Drive mechanism

(76) Inventor: Laurent Denis, Roxton Falls (CA)

Correspondence Address: JACK PAAVILA, BOX 1511, ALEXANDRIA, ON, K0C 1A0, CA

(21) Appl. No.: 10/424,880

(22) Filed: Apr. 29, 2003

(51) Int. Cl. F16H 55/36; F16H 7/20

(52) U.S. Cl. 474/199

(57) ABSTRACT

A drive mechanism for mounting on one side of a support wall to receive a drive shaft from a drive motor on the other side of the support wall, the drive shaft extending through an opening in the wall. The drive mechanism has a mounting member, the mounting member including a sleeve with a through bore, the sleeve having an inner end and outer end. The sleeve is detachably connectable at its inner end to the one side of the support wall and receives the drive shaft in its through bore when connected to the support wall. The drive mechanism also has a driven unit, the driven unit having a driven shaft, a pulley encircling the driven shaft but radially spaced therefrom, and a connector joining one side of the pulley to one end the driven shaft. The driven unit is mounted on the sleeve of the mounting member with the driven shaft inserted snugly within the bore of the sleeve from the outer end of the sleeve and the pulley concentric about the sleeve and spaced outwardly therefrom to provide an annular chamber. A bearing assembly is mounted snugly on the sleeve within the annular chamber between the pulley and the sleeve. Shaft connecting means connect the driven shaft with the drive shaft within the sleeve to have the motor, when operated, rotate the pulley about the sleeve on the bearing assembly.

### BACKGROUND OF THE INVENTION

1. Field of the Invention

This invention is directed toward a drive mechanism.

The drive mechanism of the present invention is used to transfer power from a power source, such as a hydraulic motor, to a drive belt used to rotatably operate a piece of equipment such as, for example, the cutting tool on a brush cutter.

2. Description of the Related Art

Drive mechanisms for transferring power from the output shaft of a motor power source to a drive belt are known. Usually however, the drive mechanism has the pulley mounted on the output shaft outboard of the bearing supporting the shaft and this type of mounting creates a cantilevered load on the bearing shortening its life. To avoid offset loading of the bearing, it is known to mount the bearing on the shaft so it is generally in line with the pulley. Examples are shown in U.S. Pat. Nos. 3,536,412 and 4,068,907. The known drive mechanisms have disadvantages however. The drive mechanism in pat. '412 is relatively expensive in requiring a cast part that combines the shaft 12 and the pulley 16. In addition, the bearing in the mechanism is not well sealed nor lubricated. Further, replacement of the bearing is difficult since the pump must be disassembled to be able to replace the bearing. Also, the construction is not meant for heavy duty work since the support for the bearing and pulley is made from sheet material. The drive mechanism in pat. '907 is also relatively expensive in requiring numerous pieces to securely mount the pulley onto the shaft. Again, the bearing mechanism is not well sealed and lubricated. Replacement of the bearing is difficult requiring removal of the pulley.

### SUMMARY OF THE INVENTION

It is the purpose of the present invention to provide a drive mechanism between a motor output shaft and a pulley of a belt drive that, because of its bearing mounting, is more maintenance free. More specifically it is the purpose of the present invention to provide a drive mechanism that has the bearings mounted under the pulley to provide better loading on the bearings. It is another purpose of the present invention to provide a drive mechanism that is sealed and better lubricated making its operation more reliable in dirty working conditions such as when cutting brush.

In accordance with the present invention there is provided a drive mechanism having means for mounting it on one side of a support wall, the drive mechanism receiving a drive shaft from a motor on the other side of the wall, the drive shaft extending through an opening in the wall. The drive mechanism has a mounting sleeve having an inner and an outer end. The inner end of the sleeve is mounted on the other side of the support wall and receives the drive shaft of the motor. The drive mechanism includes a drive unit comprising a driven shaft, a connector and a pulley. The pulley is concentric about, but spaced from, the driven shaft. The connector comprises a plate-like member joined at its outer periphery to one side of the pulley and joined near its center to one end of the driven shaft. The drive mechanism is mounted on the mounting sleeve with the pulley concentric about the mounting sleeve and with the driven shaft within the sleeve and connected to the drive shaft. The connector is located just outside the outer end of the sleeve. A bearing assembly is mounted in a bearing space between the pulley and the mounting sleeve, the bearing assembly directly under the pulley. The bearing space is enclosed by the connector at one end of the space and by a cover attached to the other side of the pulley at the other end of the space. The arrangement provides good support for the bearings directly under the pulleys and also provides an enclosed space for the bearings which space can be lubricated to lubricate and maintain the bearings clean. The bearings can be relatively easily replaced by removing the connector to provide access to the bearings within the bearing space.

The invention is particularly directed toward a drive mechanism for mounting on one side of a support wall to receive a drive shaft from a drive motor, the drive shaft extending through an opening in the wall. The drive mechanism has a mounting sleeve having an inner and outer end, the sleeve detachably connected at the inner end to the wall and concentrically receiving the drive shaft at its inner end. The drive mechanism has a driven unit having a driven shaft, a connector, and a pulley. The connector comprises a circular, plate-like member joined at its outer periphery to one side of the pulley and joined near its center to one end of the driven shaft. The driven unit is mounted on the other end of the sleeve with the driven shaft snugly within the sleeve and the pulley concentric about the sleeve and spaced therefrom to provide an annular chamber. A bearing assembly is mounted snugly within the annular chamber, rotatable on the sleeve and supporting the pulley for rotation.

### BRIEF DESCRIPTION OF THE DRAWINGS

FIG. 1 is a cross-section of the assembled and installed drive mechanism;

FIG. 2 is a cross-section view of the mounting member in the drive mechanism;

FIG. 3 is a cross-section view of the driven unit in the drive mechanism; and

FIG. 4 is a cross-section view of the cover in the driven unit.

### DESCRIPTION OF THE PREFERRED EMBODIMENTS

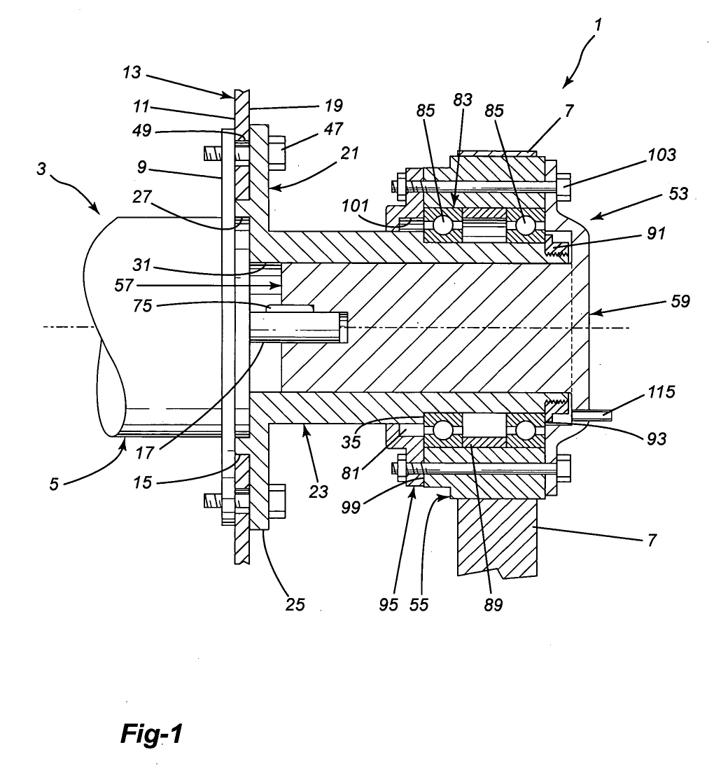

The drive mechanism 1, as shown in FIG. 1 is used to transfer power from a power source 3, such as a hydraulic motor 5, to a drive belt 7 used to rotatably operate a piece of equipment such as a brush cutter (not shown). The power source 3 is mounted at one end 9 against one side 11 of a support wall 13. There is an opening 15 in the support wall 13 and the drive shaft 17 of the power source 3 extends centrally through the opening 15.

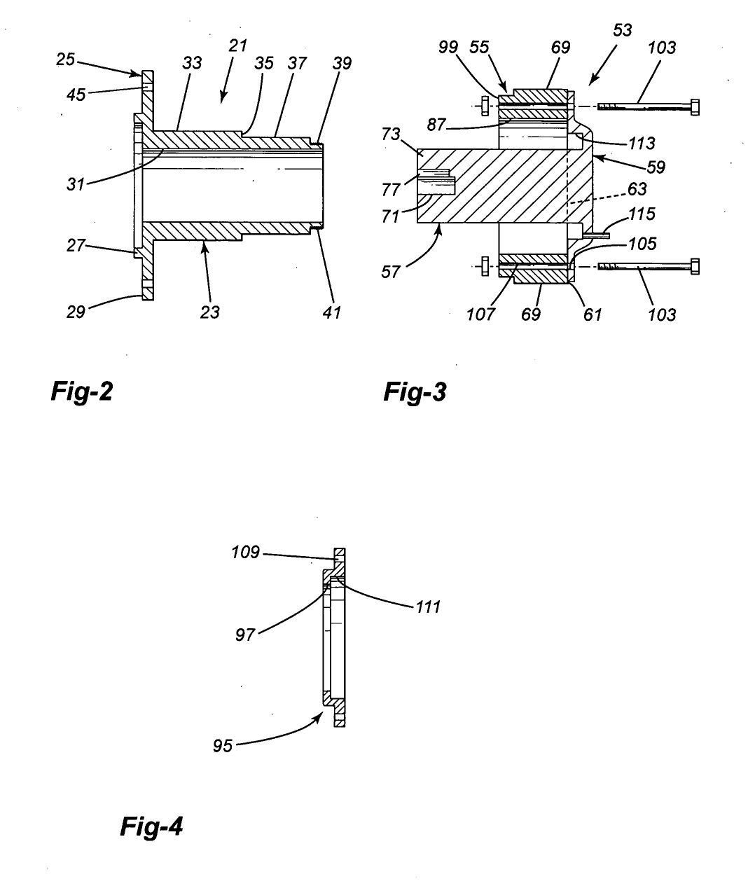

The drive mechanism 1 is mounted on the other side 19 of the support wall 13 and includes a mounting member 21 having a tubular sleeve 23. The mounting member 21, as shown in FIGS. 1 and 2, has a circular flange 25 at one end of the sleeve 23, larger than the opening 15 in the support wall 13. An annular ring 27 on the wall side 29 of the flange 25 is sized to fit snugly within the opening 15 in the wall 13 to locate the flange and sleeve 23 concentric with the opening 15 and the drive shaft 17. The sleeve 23 has a cylindrical through bore 31. The sleeve 23 has cylindrical cover surface 33 adjacent the flange 25 and then is stepped down at a first shoulder 35 to a cylindrical bearing surface 37. The bearing surface 37 is stepped down at a second shoulder 39 to a short, threaded, cylindrical end portion 41. The flange 25 has mounting holes 45 through which bolts 47 pass, the bolts 47 also passing through openings 49 in the wall 13 to connect the mounting member 21 to the wall 13. The openings 49 can be elongated to provide some adjustment if needed.

The drive mechanism 1 includes a driven unit 53. The driven unit 53, as shown in FIGS. 1 and 3, has an outer pulley 55, an inner driven shaft 57 and a connector 59 between the pulley 55 and the driven shaft 57. The connector 59 joins the one side 61 of the pulley 55 to one end 63 of the shaft 57. The driven unit 53 can be made in one piece. Preferably however, the pulley 55 is normally separate from the connector 59 and the driven shaft 57, the connector 59 and the driven shaft 57 being integral as shown in FIG. 3. The pulley 55 is joined to the connector 59 by connector connecting means, such as bolts, as will be described. The pulley 55 is in the form of an annular ring with a raised, outer, belt-receiving, cylindrical surface 69. The pulley 55 is wide enough to extend between the shoulders 35, 39 on the sleeve 23. The driven shaft 57 is sized to fit snugly within the bore 31 of the sleeve 23, extending inwardly from the end section 41 of the sleeve over most of the sleeve length. The shaft 57 has a central bore 71 extending inwardly from its free end 73 for receiving the drive shaft 17 of the motor 5. The driven shaft section 57 is connected to the drive shaft 17 by suitable shaft connecting means such as a key 75 on the drive shaft 17 received by a slot 77 on the interior of the bore 71. Other known types of shaft connecting means, such as for example, a spline connection, can be employed. The connector 59 is preferably in the form of a plate-like, circular disk.

When the driven unit 53 is mounted on the mounting member 21, the pulley 55 encircles the bearing surface 37 on the sleeve 23 but is radially spaced therefrom to form an annular bearing space 81. A bearing assembly 83, comprising two side-by-side ball bearings 85 is snugly mounted within the bearing space 81 on the bearing surface 37 on the sleeve 23 with the inner surface 87 of the pulley 55 on the bearings 85. The bearings 85 are separated by a spacer 89. The bearings 85 abut against the first stop shoulder 35 on the sleeve 23 of the mounting member 21. The bearings 85 allow the driven unit 53 to rotate about the sleeve 23 of the mounting member 21. While two ball bearings 85 have been shown to be used in the bearing assembly 83, other types of bearings, such as roller bearings, can be used. In addition, the device can be used with only one bearing.

The drive mechanism 1 includes retaining means for retaining the bearing assembly 83 in place on the sleeve 23 and for retaining the driven unit 53 in place on the bearing assembly 83. The retaining means includes a lock nut 91 that is threaded on the end portion 41 of the sleeve 23 to retain the bearings 85 on the sleeve 23 between the lock nut 91 and the first stop shoulder 35. The lock nut 91 abuts on one side 93 of the bearing assembly 83. The retaining means also includes a circular cover 95 that is rotatably mounted, via a central hole 97, on the cover surface 33 of the sleeve 23, the cover 95 abutting the other side 99 of the pulley 55 and the other side 101 of the bearing assembly 83. A set of bolts 103, forming the connector connecting means, are passed through aligned holes 105, 107 and 109 in the connector 59, the pulley 55, and the inner cover 95 respectively to join the inner cover 95 to the driven unit 53. The inner cover 95 forms part of the driven unit 53 and its abutment against the bearing assembly 83, which in turn abuts against the lock nut 91, retains the driven unit 53 on the sleeve 23 of the mounting member 21.

The inner cover 95 can be dished on its inner side, as shown at 111, and the connector 59 can be dished on its inner side, as shown at 113, to enlarge the annular bearing space 81. Lubricant can be inserted into the annular bearing space 81 through an inlet 115 in the connector 59, the inner cover 95 and the connector 59 closing the bearing space 81 to retain the lubricant within the bearing space 81.

The bearings 85 can be easily changed by removing the bolts 103 to allow removal of the connector 59 and the attached driven shaft 57, thus allowing access to the bearings 85 in the bearing space 81.

The connector 59 has been shown as being formed integrally with the driven shaft 57, but it can be separate from the driven shaft 57 and attached to it by suitable shaft connecting means.

Bolts 103 have been shown to connect the connector 59, the pulley 55 and the inner cover 95 together. However, a first set of bolts, forming the connector connecting means, can be used to connect the connector 59 to the one side of the pulley 55 and a second, separate, set of bolts, forming cover connecting means, can be used to connect the inner cover 95 to the other side of the pulley 55. Removal of the first set of bolts would allow servicing of the bearings 85 while the inner cover 95 remains connected to the pulley 55.

I claim:

1. A drive mechanism for mounting on one side of a support wall to receive a drive shaft from a drive motor on the other side of the support wall, the drive shaft extending through an opening in the wall; the drive mechanism having: a mounting member, the mounting member including a sleeve with a through bore, the sleeve having an inner end and outer end, the sleeve detachably connectable at its inner end to the one side of the support wall and concentrically receiving the drive shaft in its through bore when connected to the support wall; a driven unit, the driven unit having a driven shaft, a pulley encircling the driven shaft but radially spaced therefrom, and a connector joining one side of the pulley to one end the driven shaft; the driven unit mounted on the sleeve with the driven shaft inserted snugly within the bore of the sleeve from the outer end of the sleeve and the pulley concentric about the sleeve and spaced outwardly therefrom to provide an annular chamber; a bearing assembly mounted snugly on the sleeve within the annular chamber between the pulley and the sleeve; and shaft connecting means for connecting the driven shaft with the drive shaft within the sleeve to have the motor, when operated, rotate the pulley.

2. A drive mechanism as claimed in claim 1 including retaining means for retaining the drive unit on the mounting member and the bearing assembly within the annular chamber.

3. A drive mechanism as claimed in claim 2 wherein the retaining means includes: a nut on the end of the sleeve member to abut the one side of the bearing assembly to retain the bearing assembly on the sleeve within the annular chamber; and a cover member rotatably mounted on the sleeve and cover connecting means detachably connecting the cover to the other side of the pulley, the cover member abutting the other side of the bearing assembly;

4. A drive mechanism as claimed in claim 3 wherein the cover member is an annular plate and closes one side of the annular chamber.

5. A drive mechanism as claimed in claim 4 wherein the connector is a circular plate and closes the other side of the annular chamber.

6. A drive mechanism as claimed in claim 5 including lubricating means in the driven unit for use in inserting lubricant into the closed annular chamber.

7. A drive mechanism as claimed in claim 1 wherein the connector is integral with the driven shaft and connector connecting means detachably connect the pulley with the connector.

8. A drive mechanism as claimed in claim 7 including retaining means for retaining the drive unit on the mounting member and the bearing assembly within the annular chamber.

9. A drive mechanism as claimed in claim 8 wherein the retaining means includes: a nut on the end of the sleeve member to abut the one side of the bearing assembly to retain the bearing assembly on the sleeve within the annular chamber; and a cover member rotatably mounted on the sleeve and cover connecting means detachably connecting the cover to the other side of the pulley, the cover member abutting the other side of the bearing assembly;

10. A drive mechanism as claimed in claim 9 wherein the cover member is an annular plate and closes one side of the annular chamber.

11. A drive mechanism as claimed in claim 10 wherein the connector is a circular plate and closes the other side of the annular chamber.

12. A drive mechanism as claimed in claim 11 including lubricating means in the driven unit for use in inserting lubricant into the closed annular chamber.

13. A drive mechanism as claimed in claim 1 wherein the connector, the pulley and the driven shaft are separate elements and connector connecting means detachably connect the connector to the pulley and shaft connecting means detachably connect the connector and to the driven shaft.

14. A drive mechanism as claimed in claim 13 including retaining means for retaining the drive unit on the mounting member and the bearing assembly within the annular chamber.

15. A drive mechanism as claimed in claim 14 wherein the retaining means includes: a nut on the end of the sleeve member to abut the one side of the bearing assembly to retain the bearing assembly on the sleeve within the annular chamber; and a cover member rotatably mounted on the sleeve and cover connecting means detachably connecting the cover to the other side of the pulley, the cover member abutting the other side of the bearing assembly;

16. A drive mechanism as claimed in claim 15 wherein the cover member is an annular plate and closes one side of the annular chamber.

17. A drive mechanism as claimed in claim 16 wherein the connector is a circular plate and closes the other side of the annular chamber.

18. A drive mechanism as claimed in claim 17 including lubricating means in the driven unit for use in inserting lubricant into the closed annular chamber.

19. A drive mechanism as claimed in claim 9 wherein the cover connecting means is part of the connector connecting means.

20. A drive mechanism as claimed in claim 15 wherein the cover connecting means is part of the connector connecting means.
